(19) United States
(12) Patent Application Publication
(10) Pub. No.: US 2026/0090655 A1
(43) Pub. Date: Apr. 2, 2026

(54) PENDULUM MECHANISM

(71) Applicant: LACUNA LIMITED LIABILITY COMPANY, MOSCOW (RU)

(72) Inventors: Tatiana Nikolaevna MOSALOVA, Moscow (RU); Artem Aleksandrovich KRAVCHENKO, Moscow (RU)

(21) Appl. No.: 18/940,687

(22) Filed: Nov. 7, 2024

(30) Foreign Application Priority Data
Sep. 30, 2024 (RU) 2024129110

(51) Int. Cl. A47D 9/02; A47C 3/02; A47C 21/00; A47D 13/10

(52) U.S. Cl. CPC A47D 9/02; A47C 3/02; A47C 21/006; A47D 13/10

(57) ABSTRACT

The proposed invention relates to the furniture industry and can be used to control rocking devices, such as beds and chairs with pendulum mechanisms. A pendulum mechanism is proposed. The technical result achieved when implementing the claimed invention, in addition to the invention realizing its purpose, is the elimination of the disadvantages of analogs and thus ensuring universality, that is, the possibility of installation on both transverse pendulum mechanisms and longitudinal pendulum mechanisms, as well as the possibility of simple operation with both transverse pendulum mechanisms and longitudinal pendulum mechanisms, as well as ensuring ease of installation and operation, as well as increasing the accuracy of pendulum mechanism control.

### FIELD OF INVENTION

The present invention relates to furniture industry and can be used for controlling rocking devices, such as beds and chairs equipped with a pendulum mechanism.

### DESCRIPTION OF THE RELATED ART

There are various conventional rocking devices equipped with various actuators, such as those disclosed CN206137701U (D1), CN215686256U (D2), CN217090143U (D3), CN101015407A (D4), CN106691010A (D5), CN108851766B (D6), KR20210047022A (D7), U.S. Pat. Nos. 2,884,651A (D8), 3,769,641A (D9), 5,806,113A (D10), 8,029,377B2 (D11), 8,187,111B2 (D12), 8,307,475B2 (D13), 10,827,851B2 (D14), 9,936,818B2 (D15), 9,955,799B2 (D16), US20060207022A1 (D17), WO2005096896A1 (D18), WO2007056684A2 (D19), WO2007056700A1 (D20).

The devices known from D1-20 comprise a variety of complex systems and rocking mechanisms with lots of moving parts, which adversely affects their reliability and maintainability. Also, most of the devices known from D1-20 is not adapted to be operated remotely or automatically.

There is a conventional bed with a pendulum mechanism disclosed in RU2261641C2 (D21). The rocking device of D1 comprises a support structure, a product, and suspensions that connect the product with the support structure by means of bearings, wherein the support structure is positioned beneath the product, while the suspensions connect the support structure to the product by hinges via two axes, wherein one axis connects the support structure to the suspension, and the other axis connects the suspension to the product by means of bearings, and wherein the horizontal projection area of the support structure is smaller than that of the product.

The pendulum mechanism of D21 is set in motion externally by the user himself, with no rocking actuators.

There is another conventional bed rocking device disclosed in RU112007U1 ( [symbol] 22). The bed rocking device of D22 comprises a support structure, a bed, and suspensions that connect the bed with the support structure, an electromagnet placed on the base of the support structure and equipped with a coil that is connected to the power grid via a breaker equipped with a control unit, and a metal plate fastened to the bottom of the bed and adapted to interact with the electromagnet, the device characterized in that the metal plate is displaced relative to the electromagnet in the direction of the bed rocking.

The device of D22 is not universal and cannot be used with all types of pendulum mechanisms, being adapted only for pendulum mechanisms, in which the immovable is of suitable size, i.e., fills most of the space under the movable part. Besides, the device of D22 is difficult to install as it requires special skills needed for precise positioning of the metal plate and the electromagnet (see URL: https://web.archive.org/web/20161204121555/https://karpesh.ru/ustanovka). In addition, because only one electromagnet and one metal plate are used, there is no precise control of pendulum mechanism movements.

Therefore, the technical problem is that there is no universal device for actuating a pendulum mechanism that would work with any pendulum mechanism, including transverse and longitudinal ones, which would also be easy to install and operate.

The solution of D22 can be considered the closest prior art to the claimed invention.

### SUMMARY OF THE INVENTION

The technical problem to be solved by the claimed invention is to provide a universal device for actuating the pendulum mechanism, which would be easy to install and operate and would not possess the drawbacks of the prior art, and that could be used with both transverse pendulum mechanisms and longitudinal pendulum mechanisms, and which could be used to operate a pendulum mechanism with high precision. Another technical problem to be solved by the proposed invention is to provide new technical means, i.e., devices for actuating pendulum mechanisms.

The objective of the claimed invention, in addition to using it for intended purposes, is to overcome the drawbacks of the prior art and thus to make it universal, i.e. capable of being mounted onto both transverse pendulum mechanisms and longitudinal pendulum mechanisms, and make it easy to use with both transverse pendulum mechanisms and longitudinal pendulum mechanisms, and make it easy to install and operate, and allow for more precise operation of the pendulum mechanism.

The objective of the present invention is achieved by a device for actuating the pendulum mechanism, the device comprising a first assembly mounted onto the immovable part of the pendulum mechanism and a second assembly mounted onto the movable part of the pendulum mechanism, wherein the first assembly and the second assembly are connected to each other by a wire, wherein at least the first assembly comprises an electromagnet and the second assembly comprises an electromagnet; wherein one of the assemblies comprises at least a processor and a power source for the components of both the first assembly and the second assembly; wherein the pendulum mechanism comprises a horizontal immovable part, which is connected by at least two diagonally placed suspensions with a movable part; and wherein the first assembly and the second assembly are positioned so that their electromagnets could interact in order to move the movable part.

### BRIEF DESCRIPTION OF THE DRAWINGS

Exemplary embodiments of the present invention are described in further detail below with references made to the attached drawings, included herein by reference:

FIG. 1 illustrates an exemplary, non-limiting, embodiment of a conventional transverse pendulum mechanism 100.

FIG. 2 illustrates an exemplary, non-limiting, embodiment of a conventional longitudinal pendulum mechanism 200.

FIG. 3 illustrates a different exemplary, non-limiting, embodiment of a pendulum mechanism.

FIG. 4 illustrates an exemplary, non-limiting, embodiment of a conventional suspension 103, 203.

FIG. 5 illustrates an exemplary, non-limiting, embodiment of the proposed device 400, 500.

FIG. 6 illustrates an exemplary, non-limiting, way of how the proposed device 400, 500 can be mounted onto a transverse pendulum mechanism 100.

FIG. 7 illustrates an exemplary, non-limiting, way of how the movable part 102 of a transverse pendulum mechanism 100 can be displaced using the proposed device 400, 500.

FIG. 8 illustrates an exemplary, non-limiting, way of how the proposed device 400, 500 can be mounted onto a longitudinal pendulum mechanism 200.

FIG. 9 illustrates an exemplary, non-limiting, way of how the movable part 202 of a longitudinal pendulum mechanism 200 can be displaced using the proposed device 400, 500.

FIG. 10 illustrates an exemplary, non-limiting, overall scheme for the proposed system 600.

### DETAILED DESCRIPTION OF THE PREFERRED EMBODIMENTS

According to a preferred embodiment of the present invention, there is provided a device for actuating the pendulum mechanism, the device comprising a first assembly mounted onto the immovable part of the pendulum mechanism and a second assembly mounted onto the movable part of the pendulum mechanism, wherein the first assembly and the second assembly are connected to each other by a wire, wherein at least the first assembly comprises an electromagnet and the second assembly comprises an electromagnet; wherein one of the assemblies comprises at least a processor and a power source for the components of both the first assembly and the second assembly; wherein the pendulum mechanism comprises a horizontal immovable part, which is connected by at least two diagonally placed suspensions with a movable part; and wherein the first assembly and the second assembly are positioned so that their electromagnets could interact in order to move the movable part.

According to another preferred embodiment of the present invention, there is provided a device for actuating the pendulum mechanism, the device comprising a first assembly mounted onto the immovable part of the pendulum mechanism and a second assembly mounted onto the movable part of the pendulum mechanism, wherein the first assembly and the second assembly are connected to each other, wherein the first assembly comprises at least a power source for its components, a transceiver, a processor, and an electromagnet; wherein the second assembly comprises at least a power source for its components, a transceiver, a processor, and an electromagnet; wherein the pendulum mechanism comprises a horizontal immovable part, which is connected by at least two diagonally placed suspensions with a movable part; and wherein the first assembly and the second assembly are positioned so that their electromagnets could interact in order to move the movable part; and wherein the first assembly and the second assembly are synchronized via said transceivers so that one of the electromagnets would activate as soon as the other one is activated.

In an alternative embodiment, there is provided a device, characterized in that the pendulum mechanism is used in a bed.

In an alternative embodiment, there is provided a device, characterized in that the pendulum mechanism is used in a chair.

In an alternative embodiment, there is provided a device, wherein at least one of the assemblies comprises a memory that stores a program code that, when executed by any processor, provides activation of at least one of the electromagnets.

In an alternative embodiment, there is provided a device, wherein the memory additionally stores a program code that, when executed by any processor, provides change of propulsive effort of any of the electromagnets.

In an alternative embodiment, there is provided a device, characterized in that any of the assemblies comprises a transceiver connected to an external control device, the transceiver adapted to receive control signal to operate any of the electromagnets.

In an alternative embodiment, there is provided a device, characterized in that any of the transceivers is connected to an external control device and adapted to receive control signal to operate any of the electromagnets.

In an alternative embodiment, there is provided a device, characterized in that the pendulum mechanism is used in a bed, and the external control device is a motion sensor equipped with a transceiver, and/or a microphone equipped with a transceiver, and/or a unit equipped with a transceiver for recognizing a body position of a user of the bed.

In an alternative embodiment, there is provided a device, wherein the motion sensor is also equipped with a unit for recognizing movements of the user of the bed.

In an alternative embodiment, there is provided a device, wherein the microphone is equipped with a unit for recognizing the sounds made by the user of the bed.

According to another preferred embodiment, there is provided a pendulum mechanism comprising a horizontal immovable part, which is connected by at least two diagonally placed suspensions with a movable part, wherein the pendulum mechanism is equipped with a device for actuating the mechanism, the device comprising a first assembly mounted onto the immovable part of the pendulum mechanism and a second assembly mounted onto the movable part of the pendulum mechanism, wherein the first assembly and the second assembly are connected to each other by a wire; wherein at least the first assembly comprises an electromagnet and the second assembly comprises an electromagnet; wherein one of the assemblies comprises at least a processor and a power source for the components of both the first assembly and the second assembly; and wherein the first assembly and the second assembly are positioned so that their electromagnets could interact in order to move the movable part.

According to another preferred embodiment, there is provided a pendulum mechanism comprising a horizontal immovable part, which is connected by at least two diagonally placed suspensions with a movable part, wherein the pendulum mechanism is equipped with a device for actuating the mechanism, the device comprising a first assembly mounted onto the immovable part of the pendulum mechanism and a second assembly mounted onto the movable part of the pendulum mechanism wherein the first assembly and the second assembly are connected to each other; wherein the first assembly comprises at least a power source for its components, a transceiver, a processor, and an electromagnet; wherein the second assembly comprises at least a power source for its components, a transceiver, a processor, and an electromagnet; and wherein the first assembly and the second assembly are positioned so that their electromagnets could interact in order to move the movable part; and wherein the first assembly and the second assembly are synchronized via said transceivers so that one of the electromagnets would activate as soon as the other one is activated.

In an alternative embodiment, there is provided a mechanism, characterized in that the pendulum mechanism is used in a bed.

In an alternative embodiment, there is provided a mechanism, characterized in that the pendulum mechanism is used in a chair.

In an alternative embodiment, there is provided a mechanism, wherein at least one of the assemblies comprises a memory that stores a program code that, when executed by any processor, provides activation of at least one of the electromagnets.

In an alternative embodiment, there is provided a mechanism, wherein the memory additionally stores a program code that, when executed by any processor, provides change of propulsive effort of any of the electromagnets.

In an alternative embodiment, there is provided a mechanism, characterized in that any of the assemblies comprises a transceiver connected to an external control device, the transceiver adapted to receive control signal to operate any of the electromagnets.

In an alternative embodiment, there is provided a mechanism, characterized in that any of the transceivers is connected to an external control device and adapted to receive control signal to operate any of the electromagnets.

In an alternative embodiment, there is provided a mechanism, characterized in that the pendulum mechanism is used in a bed, and the external control device is a motion sensor equipped with a transceiver, and/or a microphone equipped with a transceiver, and/or a unit equipped with a transceiver for recognizing a body position of a user of the bed.

In an alternative embodiment, there is provided a mechanism, wherein the motion sensor is also equipped with a unit for recognizing movements of the user of the bed.

In an alternative embodiment, there is provided a mechanism, wherein the microphone is equipped with a unit for recognizing the sounds made by the user of the bed.

According to another preferred embodiment, there is provided a bed, which is equipped with any suitable pendulum mechanism.

According to another preferred embodiment, there is provided a chair, which is equipped with any suitable pendulum mechanism.

According to another preferred embodiment, there is provided an external control device for the device for actuating the pendulum mechanism, characterized in that the control device is a remote control equipped with at least an input device and a transmitter adapted to respond to a signal from the input device by sending a control signal to any of the transceivers in order to operate any of the electromagnets.

According to another preferred embodiment, there is provided an external control device for the device for actuating the pendulum mechanism, characterized in that the control device is a motion sensor equipped with a transceiver.

In an alternative embodiment, there is provided an external control device, wherein the motion sensor is also equipped with a unit for recognizing movements of the user of the bed.

According to another preferred embodiment, there is provided an external control device for the device for actuating the pendulum mechanism, characterized in that the control device is a microphone equipped with a transceiver.

In an alternative embodiment, there is provided an external control device, wherein the microphone is equipped with a unit for recognizing the sounds made by the user of the bed.

According to another preferred embodiment, there is provided an external control device for the device for actuating the pendulum mechanism, characterized in that the control device is a unit equipped with a transceiver for recognizing a body position of a user of the bed.

In an alternative embodiment, there is provided an external control device, characterized in that it is adapted to generate a control signal for the controlled device that operates at least one of the electromagnets so as to prevent displacement of the movable part of the pendulum mechanism.

In an alternative embodiment, there is provided an external control device, characterized in that it is adapted to generate a control signal for the controlled device that can turn off at least one of the electromagnets.

In an alternative embodiment, there is provided an external control device, characterized in that the control signal is formed in response to at least the signal that the body position of the user of the bed was recognized as predominantly standing.

According to another preferred embodiment, there is provided a method for actuating the pendulum mechanism, comprising the following steps: mounting a device for actuating the pendulum mechanism on the pendulum mechanism, the device comprising a first assembly mounted onto the immovable part of the pendulum mechanism and a second assembly mounted onto the movable part of the pendulum mechanism, wherein the first assembly and the second assembly are connected to each other by a wire, wherein at least the first assembly comprises an electromagnet and the second assembly comprises an electromagnet; wherein one of the assemblies comprises at least a processor and a power source for the components of both the first assembly and the second assembly; wherein the pendulum mechanism comprises a horizontal immovable part, which is connected by at least two diagonally placed suspensions with a movable part; and wherein the first assembly and the second assembly are positioned so that their electromagnets could interact in order to move the movable part; and activating the electromagnets so that they can displace the movable part.

According to another preferred embodiment, there is provided a method for actuating the pendulum mechanism, comprising the following steps: mounting a device for actuating the pendulum mechanism on the pendulum mechanism, the device comprising a first assembly mounted onto the immovable part of the pendulum mechanism and a second assembly mounted onto the movable part of the pendulum mechanism, wherein the first assembly and the second assembly are connected to each other, wherein the first assembly comprises at least a power source for its components, a transceiver, a processor, and an electromagnet; wherein the second assembly comprises at least a power source for its components, a transceiver, a processor, and an electromagnet; wherein the pendulum mechanism comprises a horizontal immovable part, which is connected by at least two diagonally placed suspensions with a movable part; and wherein the first assembly and the second assembly are positioned so that their electromagnets could interact in order to move the movable part; and wherein the first assembly and the second assembly are synchronized via said transceivers so that one of the electromagnets would activate as soon as the other one is activated; and activating the electromagnets so that they can displace the movable part.

In an alternative embodiment, there is provided a method, characterized in that the pendulum mechanism is used in a bed.

In an alternative embodiment, there is provided a method, characterized in that the pendulum mechanism is used in a chair.

In an alternative embodiment, there is provided a method, wherein at least one of the assemblies comprises a memory that stores a program code that, when executed by any processor, provides activation of at least one of the electromagnets.

In an alternative embodiment, there is provided a method, wherein the memory additionally stores a program code that, when executed by any processor, provides change of propulsive effort of any of the electromagnets.

In an alternative embodiment, there is provided a method, characterized in that any of the assemblies comprises a transceiver connected to an external control device, the transceiver adapted to receive control signal to operate any of the electromagnets.

In an alternative embodiment, there is provided a method, characterized in that any of the transceivers is connected to an external control device and adapted to receive control signal to operate any of the electromagnets.

In an alternative embodiment, there is provided a method, characterized in that the pendulum mechanism is used in a bed, and the external control device is a motion sensor equipped with a transceiver, and/or a microphone equipped with a transceiver, and/or a unit equipped with a transceiver for recognizing a body position of a user of the bed.

In an alternative embodiment, there is provided a method, wherein the motion sensor is also equipped with a unit for recognizing movements of the user of the bed.

In an alternative embodiment, there is provided a method, wherein the microphone is equipped with a unit for recognizing the sounds made by the user of the bed.

Additional alternative embodiments of the present invention are provided below. This disclosure is in no way limiting to the scope of protection granted by the present patent. Rather, it should be noted that the claimed invention can be implemented in different ways, so as to include different components and conditions, or combinations thereof, which are similar to the components and conditions disclosed herein, in combination with other existing and future technologies.

FIG. 1 is a plan view of an exemplary, non-limiting, embodiment of a conventional transverse pendulum mechanism 100. Typically, but not limited to, such transverse pendulum mechanism 100 is comprised of an immovable part 101, which is typically, but not limited to, positioned on a horizontal surface, and a movable part 102 connected to the immovable part 101 by suspensions 103.

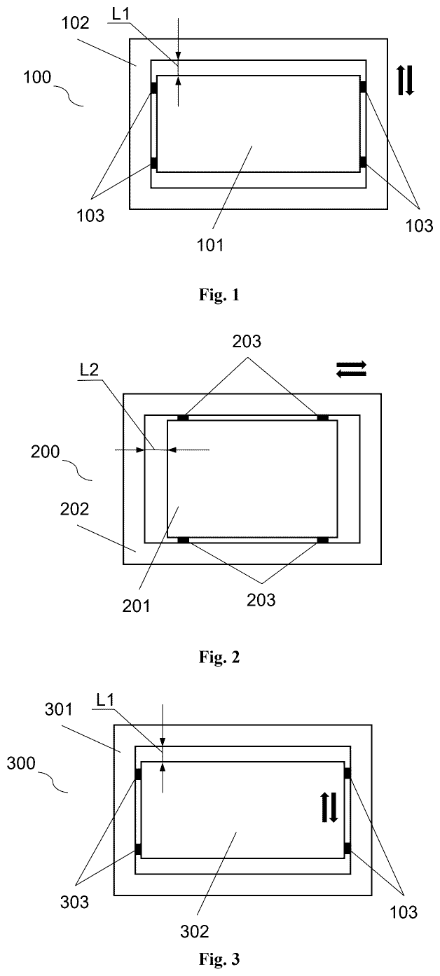

FIG. 2 illustrates an exemplary, non-limiting, embodiment of a conventional longitudinal pendulum mechanism 200. Typically, but not limited to, such longitudinal pendulum mechanism 200 is comprised of an immovable part 201, which is typically, but not limited to, positioned on a horizontal surface, and a movable part 202 connected to the immovable part 201 by suspensions 203.

FIG. 3 illustrates a different exemplary, non-limiting, embodiment of a pendulum mechanism 300. In yet another embodiment, essentially the same pendulum mechanism is provided as the pendulum mechanisms 100 and 200, but the immovable and movable parts are swapped, so that the immovable part 301 and the movable part 302 are provided. In addition, although only transverse pendulum mechanism 300 is shown in the drawing, it should be obvious to a person having ordinary skill in the art that a longitudinal pendulum mechanism 300 will be provided in the same way as the longitudinal pendulum mechanism 200. Therefore, but not limited to, there may be provided a transverse or longitudinal pendulum mechanism 300, which is comprised of an immovable part 301, which is typically, but not limited to, positioned on a horizontal surface, and a movable part 302 connected to the immovable part 301 by suspensions 303.

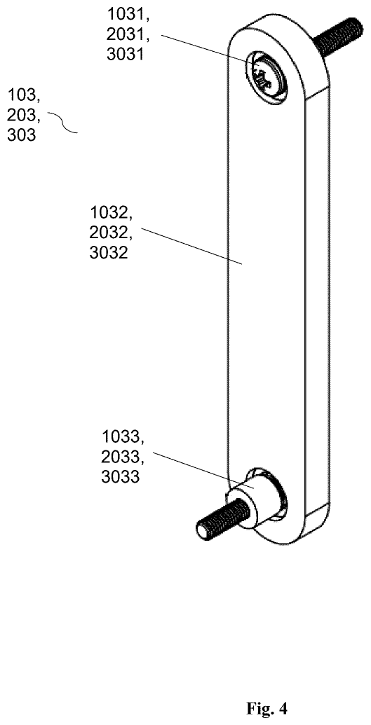

FIG. 4 illustrates an exemplary, non-limiting, embodiment of a conventional suspension 103, 203, 303. Typically, but not limited to, such suspension comprises fasteners 1031, 2031, 3031, such as bolts, screws, etc., a housing 1032, 2032, 3032 with bearings (not shown in the drawing) and, often, stiffening ribs (not shown in the drawing); wherein fasteners 1031, 2031, 3031 are equipped with bushing sleeves 1033, 2033, 3033, or one or more nuts 1033, 2033, 3033.

Typically, but not limited to, in order to be placed on a horizontal surface, the immovable part 101, 201 is equipped with at least four supports, such as stands or furniture legs, including legs equipped with furniture wheels, or one support, for example, but not limited to, in the form of a drawer with a flat rectangular bottom of sufficient dimensions to ensure stable positioning of the entire contraption. The directions in which the movable part 102, 202 can be displaced are shown by arrows. Typically, but not limited to, the top of the immovable part 101, 201 is vertically aligned with the bottom of the movable part 102, 202, wherein the maximum displacement of the movable part 102, 202 is limited within the distance L1, L2; however, but not limited to, displacement of the movable part 102, 202 is also often restricted by the suspension bearing that returns the suspension in the neutral position. In addition, it should be obvious to a person having ordinary skill in the art that four suspensions shown in FIG. 1 can be substituted with only two diagonally placed suspensions, provided that such suspensions and their fasteners ensure the overall reliability of the contraption. In addition, in order to accommodate the pendulum mechanism, the suspensions can be positioned on one side of the immovable part 101, 201, while on the other side, respectively, there may be positioned, for example, but not limited to, a groove (not shown in the drawing) providing a space for the displacement of a protrusion (not shown in the drawing) of the movable part 102, 202, wherein said protrusion provides that the movable part 102, 202 is securely supported by the immovable part 101, 201. In addition, but not limited to the immovable part 101, 201 does not have to rest on the horizontal surface in four points or be positioned on one flat surface of sufficient size; for instance, but not limited to, the immovable part 101, 201 can rest on the horizontal surface in fewer points, provided that sufficient overall reliability of the contraption is ensured. In addition, but not limited to, the immovable part 101, 201 is much smaller than the movable part 102, 202, which is especially typical of pendulum mechanisms for children's oval beds or children's transformer beds, therefore not providing enough space for mounting conventional rocking devices. Therefore, but not limited to, in general, it should be noted that the pendulum mechanism provides neutral positioning and displacement of the movable part 102, 202, 302 relative to the immovable part 101, 201, 301 with the help of suspensions 103, 203, 303; wherein the immovable part 101, 201, 301 is positioned horizontally, and, therefore, the movable part 102, 202, 302 is also positioned horizontally. In addition, preferably, but not limited to, the pendulum mechanism is used with a bed, including a child's bed or cot, or a chair.

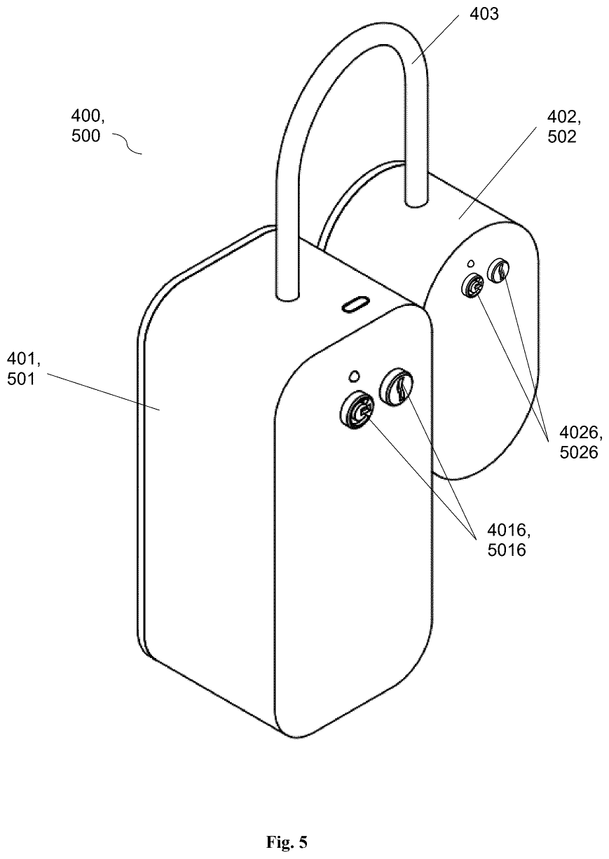

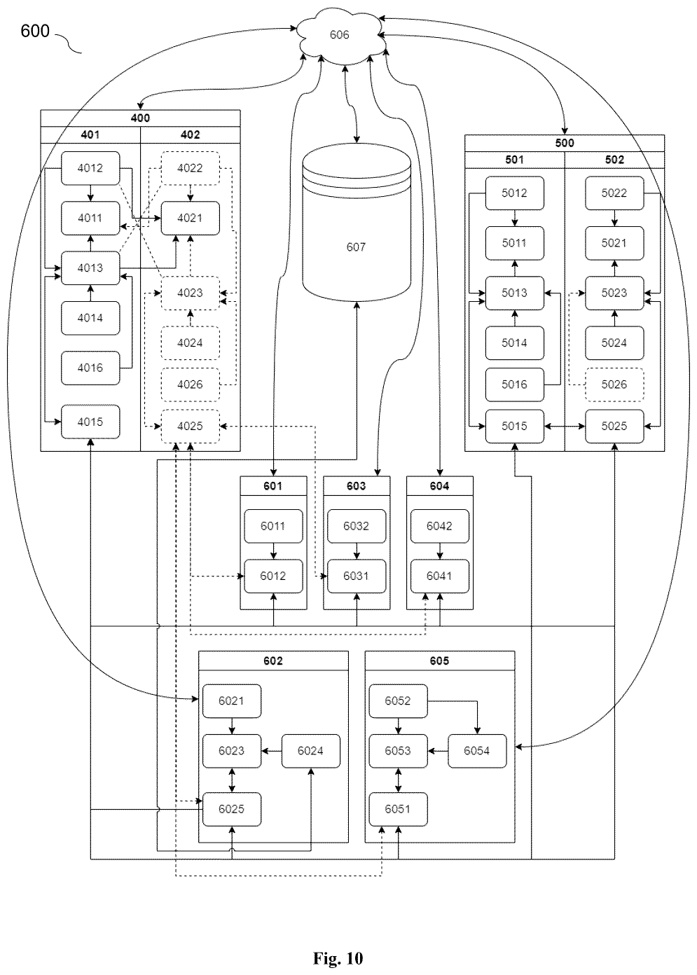

FIG. 5 illustrates an exemplary, non-limiting, embodiment of the proposed device 400, 500. According to a preferred embodiment, there is provided a device 400 for actuating the pendulum mechanism 100, 200, 300, a schematic diagram of which is shown in FIG. 10, the device 400 comprising a first assembly 401 mounted onto the immovable part 101, 201, 301 of the pendulum mechanism 100, 200, 300 and a second assembly 402 mounted onto the movable part 102, 202, 302 of the pendulum mechanism 100, 200, 300, wherein the first assembly 401 and the second assembly 402 are connected to each other by a wire 403; wherein at least the first assembly 401 comprises an electromagnet 4011 and the second assembly 402 comprises an electromagnet 4021; wherein one of the assemblies 401 or 402 comprises at least a processor 4013 or 4023, respectively, and a power source 4012 or 4022, respectively, for the components of both the first assembly 401 and the second assembly 402; wherein the first assembly 401 and the second assembly 402 are positioned so that their electromagnets 4011, 4021 could interact in order to move the movable part 102, 202, 302; and wherein the wire 403 provides power supply to and control of the components of the assembly that has no corresponding power source, or at least provides control of the corresponding electromagnet 4011 or 4021 in order to rule out possible synchronization errors that may occur otherwise, if the device's assemblies are wirelessly connected. According to another preferred embodiment, there is provided a device 500 for actuating the pendulum mechanism 100, 200, 300, a schematic diagram of which is shown in FIG. 10, the device 400 comprising a first assembly 501 mounted onto the immovable part 101, 201, 301 of the pendulum mechanism 100, 200, 300 and a second assembly 502 mounted onto the movable part 102, 202, 302 of the pendulum mechanism 100, 200, 300, wherein the first assembly 401 and the second assembly 402 are connected to each other; wherein the first assembly 501 comprises at least a power source 5012 for its components, a transceiver 5015, a processor 5013, and an electromagnet 5011; wherein the second assembly 502 comprises at least a power source 5022 for its components, a transceiver 5025, a processor 5023, and an electromagnet 5021; wherein the first assembly 501 and the second assembly 502 are positioned so that their electromagnets 5011, 5021 could interact in order to move the movable part 102, 202, 302; and wherein the first assembly 501 and the second assembly 502 are synchronized via said transceivers 5015, 5025 so that one of the electromagnets 5011 or 5021 would activate as soon as the other one 5011 or 5021 is activated. In addition, but not limited to, in the context of the present disclosure, an electromagnet 4011, 4021, 5011, 5021 can be any device that produces magnetic field of suitable power and direction when electric current passes through it, the device typically comprising, but not limited to, a coil, a ferromagnetic core, and an induction coil, such as a solenoid; wherein, preferably, the electromagnets 4011, 4021 and 5011, 5021 are paired so that they repulse each other, respectively. Preferably, but not limited to, the power source 4012, 4022, 5012, 5022 is a battery, such as electric battery, including disposable and/or rechargeable and/or storage batteries, wherein, but not limited to, the power source 4012, 4022, 5012, 5022 can also be grid powered. In addition, it should also be obvious to a person skilled in the art that the device 400, 500 has a suitable housing that protects its components from external impacts and/or unauthorized access, i.e., the housing of the device 400, 500 is considered inherent. In addition, for example, but not limited to, if there are no transceivers and/or external control devices, the device 400, 500 can be operated via any input devices 4016, 4026, 5016, 5026, such as, for example, but not limited to, buttons or sensor panels placed on at least one of the assemblies 401, 402, 501, 502 and easily accessed by the user, wherein such input device 4016, 4026, 5016, 5026 should be at least adapted to generate a control signal that is capable of actuating one of the electromagnets 4011, 4021, 5011, 5021 and/or change its operation mode when processed by a corresponding processor 4013, 4023, 5013, 5023; alternatively, but not limited to, the input device can be one or more recognition means, such as, for example, but not limited to, a gesture recognition means, a voice recognition means, etc., adapted to recognizing user's instructions and generate corresponding control signal based on it that are capable of actuating one of the electromagnets 4011, 4021, 5011, 5021 and/or change its operation mode when processed by a corresponding processor 4013, 4023, 5013, 5023.

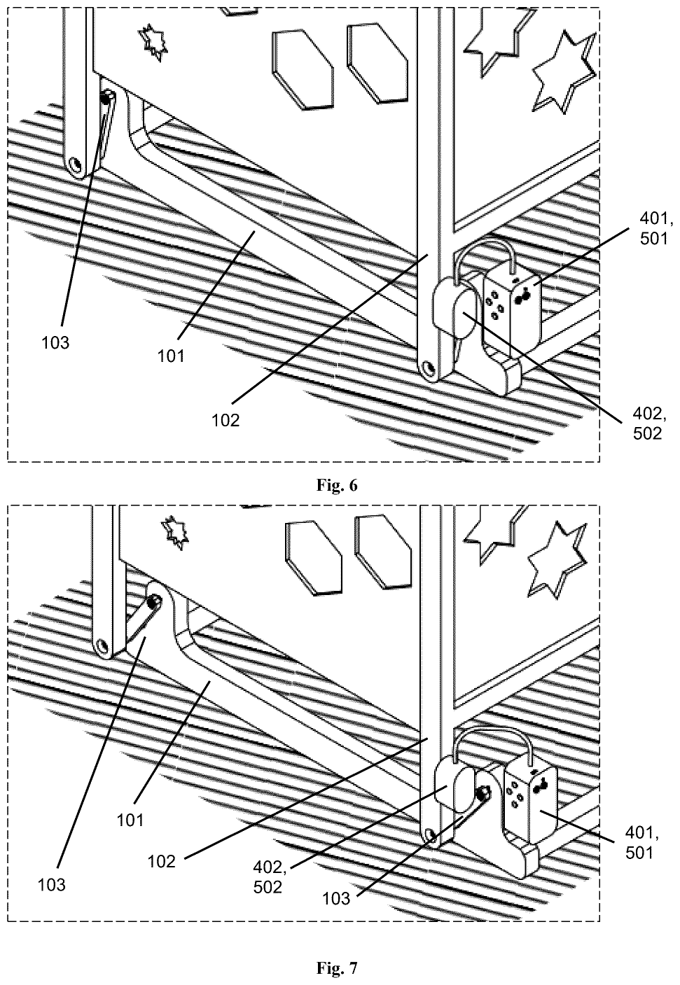

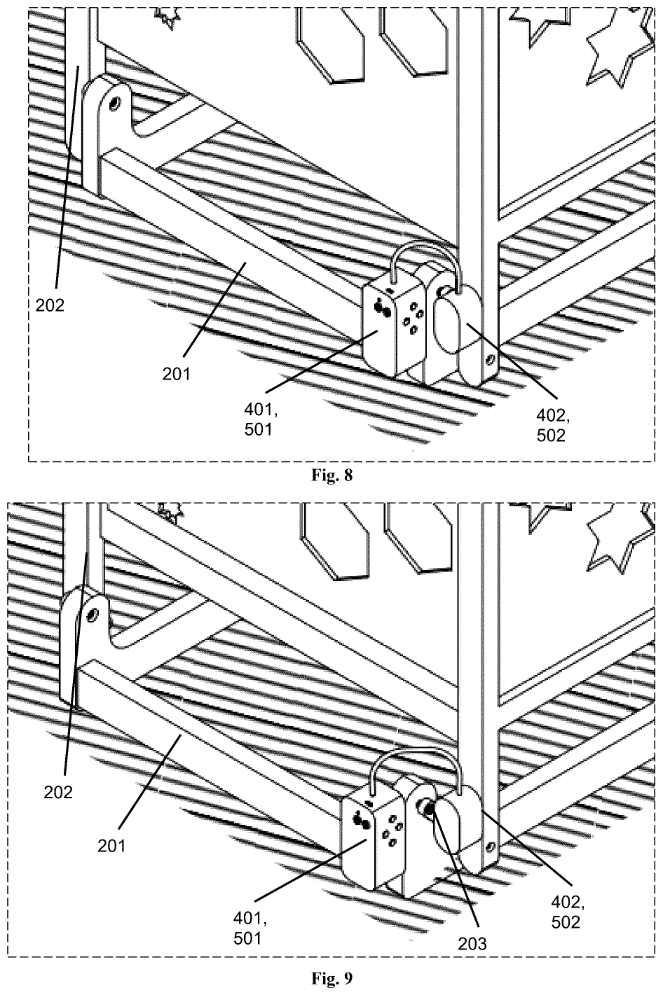

FIG. 6 illustrates an exemplary, non-limiting, way of how the proposed device 400, 500 can be mounted onto a transverse pendulum mechanism 100. FIG. 7 illustrates an exemplary, non-limiting, way of how the movable part 102 of a transverse pendulum mechanism 100 can be displaced using the proposed device 400, 500. FIG. 8 illustrates an exemplary, non-limiting, way of how the proposed device 400, 500 can be mounted onto a longitudinal pendulum mechanism 200. FIG. 9 illustrates an exemplary, non-limiting, way of how the movable part 202 of a longitudinal pendulum mechanism 200 can be displaced using the proposed device 400, 500. Preferably, but not limited to, as shown in FIGS. 6-9, the device 400, 500 is mounted onto the pendulum mechanism 100, 200 so that it is positioned near one of the suspensions 103, 203 (or, similarly, near the suspension 303 of the pendulum mechanism 300); however, despite what is shown in FIGS. 6-9, it should be obvious to a person skilled in the art that the device 400, 500 can be mounted onto the pendulum mechanism 100, 200, 300 in any suitable manner so long as it allows for interaction between the electromagnets that results in the displacement of the movable part 102, 202, 302. In addition, preferably, but not limited to, the device 400, 500 is securely mounted onto the pendulum mechanism 100, 200, 300, while also remaining easy to dismount; for example, but not limited to, back walls of the assemblies 401, 402, 501, 502 of the device 400, 500 may be equipped with a magnetic or ferromagnetic plate, and, accordingly, there may be a counterpart magnetic or ferromagnetic plate providing magnetic coupling for the corresponding assembly 401, 402, 501, 502 in the place where said assembly is to be positioned; also, for example, but not limited to, the fabric hook-and-loop fastener, also known as Velcro™ can be used, wherein the back walls of the assemblies 401, 402, 501, 502 can be equipped with one of the strips of the fastener bearing loops, and, accordingly, the other strip of the fastener bearing hooks is provided in the place where the corresponding assembly 401, 402, 501, 502 is to be positioned so that hook-and-loop coupling is provided, or, alternatively, the strip of the fastener bearing hooks can be places on the back walls of the assemblies, and, accordingly, the other strip of the fastener bearing looks can be provided in the place where the corresponding assembly 401, 402, 501, 502 is to be positioned so that said hook-and-loop coupling is provided; wherein, in the context of the present disclosure, the fabric fastener can be any conventional variant of the fabric fastener, which is known now or will be known in the future, that provides secure coupling between the two parts of the fastener, such as, for example, but not limited to, the fastener of U.S. Pat. No. 5,983,467A (included herein by reference), a 3M™ Dual Lock™ fastener, etc.; and wherein it should be obvious to a person skilled in the art that the dimensions of magnetic or ferromagnetic plates, as well as the size of the fabric fasteners are selected based on the size, dimensions, and weight of the assemblies 401, 402, 501, 502 and the parameters of the place where they are to be positioned, so that the assemblies 401, 402, 501, 502 are securely mounted onto the pendulum mechanism 100, 200, 300 and are, at least, securely held on the movable part 102, 202, 302 during the operation of the device 400, 500.

FIG. 10 illustrates an exemplary, non-limiting, overall scheme for the proposed system 600 for actuating the pendulum mechanism 100, 200, 300. Preferably, but not limited to, the processor 4013, 4023, 5013, 5023 is both the chip itself and the rest of the processor and/or microprocessor components, such as, for example, but not limited to, microcontrollers, drivers, cash memory and other electronic devices, including breakers and/or pulse generators that enable the electromagnets 4011, 4021, 5011, 5022 to operate intermittently. Preferably, it should be generally noted that the processor, which is therefore a control unit, provides at least control over the activation/deactivation of any of the electromagnets 4011, 4021, 5011, 5022, so as to provide oscillating movement of the movable part 102, 202, 302. At the same time, such control unit can also change the propulsive effort of any of the electromagnets 4011, 4021, 5011, 5022, either via software or signals (pulses), as well as, optionally, but not limited to, provide certain scripts of changing said power; wherein, but not limited to, when program code is used, the code in question may be stored either directly in the memory (cache memory) of the processor 4013, 4023, 5013, 5023 of either the control unit or even the microcontroller, or in an external memory 4014, 4024, 5014, 5024, which is a separate component of the device 400, 500; nevertheless, but not limited to, in the context of the present disclosure, the memory 4014, 4024, 5014, 5024 is at least equivalent in functionality to any built-in memory of the processor, microcontroller, etc. Therefore, but not limited to, any of the assemblies 401, 402 of the device 400 may be, accordingly, equipped with the memory 4014, 4024, while any of the assemblies 501, 502 may be, accordingly, equipped with the memory 5014, 5024, wherein such memory 4014, 4024, 5014, 5024 may contain a program code, which, when executed by any of the processors 4013, 4023, 5013, 5023, actuates at least one of the electromagnets 4011, 4021, 5011, 5021; wherein, additionally, such code, or another program code also contained in the memory 4014, 4024, 5014, 5024, may, when executed by any of the processors 4013, 4023, 5013, 5023, change the propulsive effort of any of the electromagnets 4011, 4021, 5011, 5022, as well as, optionally, but not limited to, provide certain scripts of changing said power, i.e. provide certain operation scripts for the electromagnets 4011, 4021, 5011, 5021, where, for example, but not limited to, the propulsive effort is changed in sequence so as to provide a pre-determined changes in the movement of the movable part 102, 202, 302. In addition, said memory 4014, 4024, 5014, 5024 may also contain a program code, which, when executed by said processor 4013, 4023, 5013, 5023, changes the extent of mutual impact or interaction between the electromagnet pairs, i.e. between the electromagnets 4011, 4021 and electromagnets 5011, 5021, by, for example, but not limited to, measuring induced electromotive force that affects a conductor in order to determine the distance between the electromagnets, whereby, but not limited to, at least the position of the assembly mounted onto the movable part 102, 202, 303 relative to the assembly mounted onto the immovable part 101, 201, 301 can be determined; and therefore, for example, but not limited to, when the overall dimensions of the assembly 401, 402, 501, 502 and the position of the given electromagnet 4011, 4021, 5011, 5021 relative to the mounting location of the corresponding assembly 401, 402, 501, 502 are known, then the position of the movable part 102, 202, 302 relative to the immovable part 101, 201, 301 can be determined, whereby, for example, but not limited to, the operation of the corresponding electromagnet 4011, 4021, 5011, 5021 can be adjusted, or its script can be changed, so as to achieve the desired position of the movable part 102, 202, 302 relative to the immovable part 101, 201, 301. In addition, but not limited to, any of the assemblies 401, 402 of the device 400 may be additionally equipped with a transceiver 4015, 4025 that is used to communicate with an external control device 601 adapted to at least receiving a control signal to operate any of the electromagnets 4011, 4021 via the processor 4013, 4023, whereas the assemblies 501, 502 of the device 500 are already equipped with transceivers 5015, 5025 which provide synchronization between the assemblies 501, 502 so that the electromagnets 5011, 5012 are activated predominantly synchronously; however, any of the transceivers 5015, 5025 may be further adapted to at least receiving a control signal to operate any of the electromagnets 5011, 5021 via the processor 5013, 5023. In addition, but not limited to, the external control device may be, for example, but not limited to, a remote control 601 equipped with at least an input device 6011 and a transceiver 6012 through which the user can interact with the remote control and make it send corresponding control signals to the transceivers 4015, 4025, 5015, 5025. In addition, the remote control may be based on a user device 602, such as, for example, but not limited to, a smartphone, a tablet, a laptop, a PC, a multifunctional customizable remote control, a Personal Voice Assistant, etc. In this case, but not limited to, such user device 602 comprises at least an input device 6021, such as, for example, a button or a microphone, or an I/O device 6021, such as, for example, but not limited to, a touchscreen; a transceiver 6012; a processor 6023; and a memory 6024 that stores at least a program code, which, when executed by the processor 6023, incites the processor 6023 to generate a GUI that provides at least an interaction area, through which the user can interact with the user device 602 and make it send corresponding control signals to the transceivers 4015, 4025, 5015, 5025 via the transceiver 6025 of the device 602, as well as receive feedback from the transceivers 4015, 4025, 5015, 5025, such as, for example, current operation parameters, battery levels, etc. Alternatively, but not limited to, the external control device may be, for example, but not limited to, a motion sensor 603 equipped with a transceiver 6031, wherein, for example, but not limited to, such motion sensor 603 may be additionally equipped with a unit 6032 for recognizing a body position of the user of the bed, the unit 6032 adapted to calculate at least a duration of movement of the user of the bed; and wherein, therefore, a control signal is automatically generated upon detecting the movement of the user of the bed, or, accordingly, upon detecting a pre-determined sequence of movements of the user of the bed, and then sent to the corresponding transceiver 4015, 4025, 5015, 5025 in order to actuate the electromagnets 4011, 4021, 5011, 5021. Alternatively, but not limited to, the external control device may be, for example, but not limited to, a microphone 604 equipped with a transceiver 6041, wherein, for example, but not limited to, such microphone 604 may be additionally equipped with a unit 6042 for recognizing the sounds made by the user of the bed, adapted to calculate at least the duration of the sounds made by the user of the bed; and wherein, therefore, a control signal is automatically generated upon detecting the sound made by the user of the bed, or, accordingly, upon detecting a pre-determined sequence of sounds made by the user of the bed, and then sent to the corresponding transceiver 4015, 4025, 5015, 5025 in order to actuate the electromagnets 4011, 4021, 5011, 5021. Alternatively, but not limited to, the external control device may be, for example, but not limited to, a unit 605 for recognizing the body position of the user of the bed, the unit 605 equipped with a transceiver 6051, in addition, for example, but not limited to, such unit 605 typically comprises at least one video camera 6052 adapted to obtain a series of frames, as well as a processor 6053 and a memory 6054 which stores a program code, which, when executed by the processor 6053 in response to the series of frames obtained, recognizes the body position of the user of the bed based on, for example, but not limited to, a trained classification or clustering model, whereby the control signal is generated automatically upon recognizing the bed body position of the user of the bed that can be classified at least as ‘lying down’ or as ‘standing up’ and then sent to the corresponding transceiver 4015, 4025, 5015, 5025 in order to change the operation of the electromagnets 4011, 4021, 5011, 5021, particularly, at least, by turning off at least one of the electromagnets and thus killing magnetic traction that is driving the displacement of the movable part 102, 202, 302, or, for example, but not limited to, to make at least one of the electromagnets operate in such a way that prevents the movable part 102, 202, 302 from being displaced, i.e. providing a kind of magnetic lock. Preferably, but not limited to, such signals are generated in response to the unit 605 receiving a signal that the body position of the user of the bed has been recognized as predominantly standing up, which provides the safety of the user while using the bed. In addition, but not limited to, the device 400, 500 and at least the user device 602, as well as, optionally, the motion sensor 603, microphone 604, and unit 605 for recognizing the body position of the user of the bed, can be connected with each other via a network 606, wherein the user device 602 can be used as a basis for implementing a server 602, wherein the server 602 is equivalent to the user device 602, the only difference being that the server 602 does not necessarily comprise an input device and may also be implemented on the basis of another computer device comprising at least a memory and a processor.

In addition, for example, but not limited to, the memory (the computer-readable medium) may comprise a non-volatile memory (NVRAM); a random-access memory (RAM); a read-only memory (ROM); an electrically erasable programmable read-only memory (EEPROM); a flash drive or other memory technologies; a CD-ROM, a digital versatile disk (DVD) or other optical/holographic media; magnetic tapes, magnetic film, a hard disk drive or any other magnetic drive; and any other medium capable of storing and encoding the necessary information. In addition, but not limited to, the memory comprises a computer-readable medium based on the computer memory, either volatile or non-volatile, or a combination thereof. In addition, but not limited to, exemplary hardware devices include solid-state drives, hard disk drives, optical disk drives, etc. For instance, but not limited to, the computer-readable medium (memory) is not a temporary memory (i.e., a permanent, non-transitory memory), and therefore it does not contain a temporary (transitive) signal. In addition, but not limited to, the user device's 602 (server 602) memory 6024 may store an exemplary environment, in which the device 400, 500 may be operated through computer instructions or codes, such as those stored in the memory 6024 of the server 602, including generating scripts for electromagnets 4011, 4021, 5011, 5021. In addition, but not limited to, the system 600 may further comprise a database 607. The database 607 may be, but not limited to, a hierarchical database, a network database, a relational database, an object database, an object-oriented database, an object-relational database, a spatial database, a combination of two or more said databases, etc. In addition, but not limited to the database 607 stores at least pre-generated scripts for electromagnets 4011, 4021, 5011, 5021, as well as the data for analysis and recognition and other information that is kept in the memory 6024 or any other suitable memory of a different computer device that is connected to the user device 602 and/or server 602, wherein said memory may be identical to the memory 6024, but not limited to, as was disclosed above, and accessed via the server 602 and network 606. In addition, but not limited to, there is provided a server 602, which, in addition to the functions mentioned above, is capable of storing and facilitating the execution of computer-readable commands and codes disclosed herein, which, accordingly, will not be described again. In addition, but not limited to, the server 602, in addition to the functions mentioned above, is capable of controlling the data exchange in the system 600. In addition, but not limited to, data exchange within the system 600 is executed with the help of one or more data exchange networks 606. In addition, but not limited to, data exchange networks 606 may include, but not limited to, one or more local area networks (LAN) and/or wide area networks (WAN), or may be represented by the Internet or Intranet, or a virtual private network (VPN), or a combination thereof, etc. In addition, but not limited to, the server 602 is further capable of providing a virtual computer environment for the components of the system 600 to interact with each other. In addition, but not limited to, the network 606 enables interaction between the user device 602 and/or server 602 and, optionally, the database 607. In addition, but not limited to, the database 607 may be located in the memory 6024. In addition, typically, but not limited to, components of devices 400, 500, 601, 602, 603, 604, 605 are connected to each other via a data bus, among other ways. In addition, but not limited to, the external control device may comprise any suitable combination of devices 601, 602, 603, 604, 605.

Therefore, but not limited to, there may be provided a set comprising a bed equipped with a pendulum mechanism 100, 200, 300 comprising a horizontal immovable part 101, 201, 301, which is connected by at least two diagonally placed suspensions 103, 203, 303 with a movable part 102, 202, 302, and a device 400 for actuating the pendulum mechanism adapted to be mounted onto the pendulum mechanism 100, 200, 300, the device 400 comprising a first assembly 401 adapted to be mounted onto the immovable part of the pendulum mechanism and a second assembly 402 adapted to be mounted onto the movable part of the pendulum mechanism, wherein the first assembly 401 and the second assembly 402 are connected to each other by a wire; wherein at least the first assembly 401 comprises an electromagnet 4011 and the second assembly 402 comprises an electromagnet 4021; wherein one of the assemblies 401 or 402 comprises at least a processor 4013 or 4023, respectively, and a power source 4012 or 4022, respectively, for the components of both the first assembly 401 and the second assembly 402; wherein the first assembly 401 and the second assembly 402 are adapted to be positioned so that their electromagnets 4011, 4021 could interact in order to move the movable part 102, 202, 302; wherein, optionally, the device 400 is characterized in that any of the assemblies 401 or 402 comprises a transceiver 4015 or 4025, respectively, connected to an external control device 601, 602, 603, 604, 605, the transceiver adapted to receive control signal to operate any of the electromagnets 4011 or 4021; and wherein the set further comprises an external control device 601, and/or 602, and/or 603, and/or 604, and/or 605, or any combination thereof.

Therefore, but not limited to, there may be provided a set comprising a bed equipped with a pendulum mechanism 100, 200, 300 comprising a horizontal immovable part 101, 201, 301, which is connected by at least two diagonally placed suspensions 103, 203, 303 with a movable part 102, 202, 302, and a device 500 for actuating the pendulum mechanism adapted to be mounted onto the pendulum mechanism 100, 200, 300, the device 500 comprising a first assembly 501 adapted to be mounted onto the immovable part 101, 201, 301 of the pendulum mechanism 100, 200, 300 and a second assembly 502 adapted to be mounted onto the movable part 102, 202, 302 of the pendulum mechanism 100, 200, 300, wherein the first assembly 401 and the second assembly 402 are connected to each other; wherein the first assembly 501 comprises at least a power source 5012 for its components, a transceiver 5015, a processor 5013, and an electromagnet 5011; wherein the second assembly 502 comprises at least a power source 5022 for its components, a transceiver 5025, a processor 5023, and an electromagnet 5021; wherein the first assembly 501 and the second assembly 502 are adapted to be positioned so that their electromagnets 5011, 5021 could interact in order to move the movable part 102, 202, 302; and wherein the first assembly 501 and the second assembly 502 are synchronized via said transceivers 5015, 5025 so that one of the electromagnets would activate as soon as the other one is activated; and wherein, optionally, the set further comprises an external control device 601, and/or 602, and/or 603, and/or 604, and/or 605, or any combination thereof.

Therefore, but not limited to, there may be provided a set comprising a chair equipped with a pendulum mechanism 100, 200, 300 comprising a horizontal immovable part 101, 201, 301, which is connected by at least two diagonally placed suspensions 103, 203, 303 with a movable part 102, 202, 302, and a device 400 for actuating the pendulum mechanism adapted to be mounted onto the pendulum mechanism 100, 200, 300, the device 400 comprising a first assembly 401 adapted to be mounted onto the immovable part of the pendulum mechanism and a second assembly 402 adapted to be mounted onto the movable part of the pendulum mechanism, wherein the first assembly 401 and the second assembly 402 are connected to each other by a wire; wherein at least the first assembly 401 comprises an electromagnet 4011 and the second assembly 402 comprises an electromagnet 4021; wherein one of the assemblies 401 or 402 comprises at least a processor 4013 or 4023, respectively, and a power source 4012 or 4022, respectively, for the components of both the first assembly 401 and the second assembly 402; wherein the first assembly 401 and the second assembly 402 are adapted to be positioned so that their electromagnets 4011, 4021 could interact in order to move the movable part 102, 202, 302; wherein, optionally, the device 400 is characterized in that any of the assemblies 401 or 402 comprises a transceiver 4015 or 4025, respectively, connected to an external control device 601, 602, 603, 604, 605, the transceiver adapted to receive control signal to operate any of the electromagnets 4011 or 4021; and wherein the set further comprises an external control device 601.

Therefore, but not limited to, there may be provided a set comprising a chair equipped with a pendulum mechanism 100, 200, 300 comprising a horizontal immovable part 101, 201, 301, which is connected by at least two diagonally placed suspensions 103, 203, 303 with a movable part 102, 202, 302, and a device 500 for actuating the pendulum mechanism adapted to be mounted onto the pendulum mechanism 100, 200, 300, the device 500 comprising a first assembly 501 adapted to be mounted onto the immovable part 101, 201, 301 of the pendulum mechanism 100, 200, 300 and a second assembly 502 adapted to be mounted onto the movable part 102, 202, 302 of the pendulum mechanism 100, 200, 300, wherein the first assembly 401 and the second assembly 402 are connected to each other; wherein the first assembly 501 comprises at least a power source 5012 for its components, a transceiver 5015, a processor 5013, and an electromagnet 5011; wherein the second assembly 502 comprises at least a power source 5022 for its components, a transceiver 5025, a processor 5023, and an electromagnet 5021; wherein the first assembly 501 and the second assembly 502 are adapted to be positioned so that their electromagnets 5011, 5021 could interact in order to move the movable part 102, 202, 302; and wherein the first assembly 501 and the second assembly 502 are synchronized via said transceivers 5015, 5025 so that one of the electromagnets would activate as soon as the other one is activated; and wherein, optionally, the set further comprises an external control device 601.

The present disclosure of the claimed invention demonstrates only certain exemplary embodiments of the invention, which by no means limit the scope of the claimed invention, meaning that it may be embodied in alternative forms that do not go beyond the scope of the present disclosure and which may be obvious to persons having ordinary skill in the art.

1. A pendulum mechanism comprising a horizontal immovable part, which is connected by at least two diagonally placed suspensions with a movable part, wherein the pendulum mechanism is equipped with a device for actuating the mechanism, the device comprising a first assembly mounted onto the immovable part of the pendulum mechanism and a second assembly mounted onto the movable part of the pendulum mechanism, wherein the first assembly and the second assembly are connected to each other by a wire; wherein at least the first assembly comprises an electromagnet and the second assembly comprises an electromagnet; wherein one of said assemblies comprises at least a processor and a power source for the components of both the first assembly and the second assembly; and wherein the first assembly and the second assembly are positioned so that their electromagnets could interact in order to move the movable part.

2. The mechanism of claim 1, characterized in that the pendulum mechanism is used in a bed.

3. The mechanism of claim 1, characterized in that the pendulum mechanism is used in a chair.

4. The mechanism of claim 1, characterized in that at least one of the assemblies comprises a memory that stores a program code that, when performed by any CPU, ensures activation of at least one of the electromagnets.

5. The mechanism of claim 4, wherein the memory additionally stores a program code that, when executed by any processor, provides change of propulsive effort of any of said electromagnets.

6. The mechanism of claim 1, characterized in that any of said assemblies comprises a transceiver connected to an external control device, the transceiver adapted to receive control signal to operate any of said electromagnets.

7. The mechanism of claim 6, wherein the pendulum mechanism is used in a bed, and the external control device is a motion sensor equipped with a transceiver, and/or a microphone equipped with a transceiver, and/or a unit equipped with a transceiver for recognizing a body position of a user of the bed.

8. The mechanism of claim 7, wherein the motion sensor is also equipped with the unit for recognizing movements of the user of the bed.

9. The mechanism of claim 7, wherein the microphone is equipped with a unit for recognizing the sounds made by the user of the bed.
